(19) United States
(12) Patent Application Publication
(10) Pub. No.: US 2013/0024524 A1
(43) Pub. Date: Jan. 24, 2013

(54) TARGETED MESSAGING SYSTEM AND METHOD

(71) Applicants: John Graff, Provo, UT (US); Dane Dellenbach, Provo, UT (US); Bruce Hassler, Mapleton, UT (US); Jacob Stephen Hutchings, Provo, UT (US); David George Przybyla, Orem, UT (US); Thomas Edward Lane, Spanish Fork, UT (US); Daniel Bartholomew Stovall, Provo, UT (US); Tyson Loric Holmes, American Fork, UT (US)

(72) Inventors: John Graff, Provo, UT (US); Dane Dellenbach, Provo, UT (US); Bruce Hassler, Mapleton, UT (US); Jacob Stephen Hutchings, Provo, UT (US); David George Przybyla, Orem, UT (US); Thomas Edward Lane, Spanish Fork, UT (US); Daniel Bartholomew Stovall, Provo, UT (US); Tyson Loric Holmes, American Fork, UT (US)

(73) Assignee: PARLANT TECHNOLOGY, INC., Provo, UT (US)

(21) Appl. No.: 13/348,221

(22) Filed: Jan. 11, 2012

Related U.S. Application Data
(63) Continuation-in-part of application No. 13/188,393, filed on Jul. 21, 2011.

(51) Int. Cl. G06F 15/16

(52) U.S. Cl. 709/206

(57) ABSTRACT

Various implementations of the present invention are provided as a network computer system configured to allow for creating, rating, tracking, monitoring, and disseminating user-created and user-customizable messages. The network computer system provides a user interface that allows a user to create templates for message creation, messages from the templates, ratings for messages (message “bias”), databases for storing templates and messages (message queue), and ratings, as well as storage for information related to the monitoring and tracking of messages as they are delivered to the intended recipients. The ability to create multiple messages, with disparate content, intended for disparate audiences, with batch sorting and sending, is also provided. Messages can be provided via commercial messaging services such as email, snail mail, telephone, SMS, facsimile, social media networking sites (e.g. Facebook® messages, Twitter® “tweets”, etc.). In some implementations of the invention, a computer-implemented method of messaging for an educational environment is provided.

### CROSS-REFERENCE TO RELATED APPLICATION

This application is a continuation-in-part of U.S. patent application Ser. No. 13/188,393, which application was filed on Jul. 21, 2011, which application is now pending and which application is incorporated by reference herein.

### BACKGROUND OF THE INVENTION

1. Technical Field

The present invention relates generally to the field of communication and messaging and more specifically relates to systems and methods for creating and disseminating targeted messages to one or more interested parties.

2. Background Art

Schools, businesses, government agencies, and other entities often find it necessary and/or desirable to provide informational messages and alerts to certain individuals and groups of individuals. The primary purpose is typically to communicate relevant information regarding operational and policy decisions that affects the individual or group or their relationship with the sender of the message or alert. For example, it is a commonplace activity for many businesses, government agencies, schools, churches, etc. to provide messages to an individual or group of individuals regarding informational updates, details for upcoming events, changes to scheduled events, policies and procedures, reports and results of activities, etc.

In some school districts, administrators recognize that certain teachers tend to send more messages to parents reporting on undesirable student behavior than messages reporting on desirable student behavior. Many schools and school districts also recognize that increasing the number of positive student behavior messages compared to the number of negative on student behavior messages would likely foster a better relationship between the school and parents, which could have an impact on student learning. Accordingly, it may be desirable to increase the ratio of positive student behavior communications to negative student behavior communications.

There are a wide variety of known systems and processes available for providing messages and alerts to individuals and groups of individuals. These include both manual and automated systems, with many computerized messaging systems now being offered by various companies. Computerized messaging systems can be used to generate email messages, voice messages, text messages, etc. to send to one or more interested individuals or groups of individuals.

Many organizations and agencies, including commercial businesses, governments, and schools, have adopted and implemented computerized messaging systems, with varying degrees of success. In most cases, the computerized messaging systems are limited to the specific functions and features that have been pre-designed by the makers of the system and provide little opportunity for customization. However, since the communication of timely and effective messages is a vital function for most organizations, these computerized messaging systems have been broadly adopted in many locations and environments.

While the ability to efficiently and effectively create and send messages and alerts is highly desirable, and often vital, there are some issues associated with the adoption and implementation of computerized messaging systems. For example, many organizations do not have the optimal number of staff and/or equipment necessary to effectively and efficiently create, deliver, track and report the results of automated or semi-automated messaging campaigns. This may lead to inaccuracies or gaps in the delivery of the message to the intended recipients.

Additionally, given the wide variety of the number and frequency of messages, potential recipients, and message content that may be required by disparate organizations, it is difficult for many organizations to find a standard messaging solution that meets their specific needs, leading them to accept a less than satisfactory solution. Finally, from a budgetary perspective, the costs associated with implementing messaging systems can be daunting for many organizations, particularly schools and non-profit organizations. However, since creating and monitoring the delivery of messages to the relevant constituency is vital to so many operations, it is rarely an optional activity. Accordingly, without improvements in the current systems, procedures, and methods for messaging, the overall process and user experience will continue to be sub-optimal.

### BRIEF SUMMARY OF THE INVENTION

The various implementations of the present invention are provided as a network computer system configured to allow for creating, rating, tracking, monitoring, and disseminating user-created and user-customizable messages. The network computer system provides a user interface that allows a user to create templates for message creation, messages from the templates, ratings for messages, databases for storing templates, messages, and ratings, as well as storage for information related to the monitoring and tracking of messages as they are delivered to the intended recipients. The ability to create multiple messages, with disparate content, intended for disparate audiences, with batch sorting and sending, is also provided. Messages can be provided via email, snail mail, telephone, SMS, facsimile, social networking sites and services (“tweets”), etc. In at least one implementation of the present invention, a computer-implemented method of messaging for an educational environment is provided.

### BRIEF DESCRIPTION OF THE FIGURES

The preferred embodiments of the present invention will hereinafter be described in conjunction with the appended drawings, wherein like designations denote like elements, and:

FIG. 1 is a perspective view of a network computer system for providing targeted messaging services in accordance with a preferred exemplary embodiment of the present invention;

FIG. 2 is a block diagram of a server used for implementing a network computer system for providing targeted messaging services in accordance with a preferred exemplary embodiment of the present invention;

FIG. 3 is a block diagram of user interaction with a system for providing targeted messaging services in accordance with a preferred exemplary embodiment of the present invention;

FIG. 4 is a block diagram of a method for creating targeted messages with a system for providing targeted messaging services in accordance with a preferred exemplary embodiment of the present invention; and

FIG. 5 is a schematic diagram of a message created by a system for providing targeted messaging services in accordance with preferred exemplary embodiment of the present invention.

### DETAILED DESCRIPTION OF THE INVENTION

The various implementations of the present invention are provided as a network computer system configured to allow for creating, rating, tracking, monitoring, and disseminating user-created and user-customizable messages. The network computer system provides a user interface that allows a user to create templates for message creation, messages from the templates, ratings for messages, databases for storing templates, messages, and ratings, as well as storage for information related to the monitoring and tracking of messages as they are delivered to the intended recipients. Further, a wide variety of user and system generated reports can be created and accessed, allowing for review of messages. Further, automated and manual targeted messaging related to desired activities and events can be quickly and easily created and sent. The ability to create multiple messages, with disparate content, intended for disparate audiences, with batch sorting and sending, is also provided. Messages can be provided via email, snail mail, telephone, SMS, facsimile, social networking sites and services (“tweets”), etc. In at least one implementation of the present invention, a computer-implemented method of messaging for an educational environment is provided.

The various preferred embodiments of the present invention are specifically designed to provide a user-configurable platform for generating communications (each a “message event”) to a wide variety of users, via multiple communication methodologies. The message events are any form of communication and may include communications such as updates, alerts, warnings, etc.

Aspects of the messaging system are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Additionally, various preferred embodiments of the program product may be configured to: create and modify multiple databases; track, update and store data relative to messages, including tracking and reporting; configure and implement various search and retrieve functions for a multitude of search requests and determinations made by users of the system; track and store information about various services and fees; update and transmit search results to one or more users; and provide one or more user interfaces for accomplishing all of these functions.

In this fashion, the appropriate entities (i.e., supervisors, employees, administrators, managers, teachers, parents, students, etc.) can utilize the program product to initiate and complete a wide variety of database-related applications for the provision of creating and disseminating targeted messages. Similarly, a program product in accordance with one or more preferred embodiments of the present invention can also be configured to perform substantially all of the steps depicted and described in conjunction with the figures below for implementing targeted messaging system as described herein.

While the present invention will be described in detail by using various examples of a typical educational environment, those skilled in the art will recognize that the equipment, processes, methods and techniques described herein have broad applicability to other environments and applications where quick and efficient access to targeted messaging services is desirable.

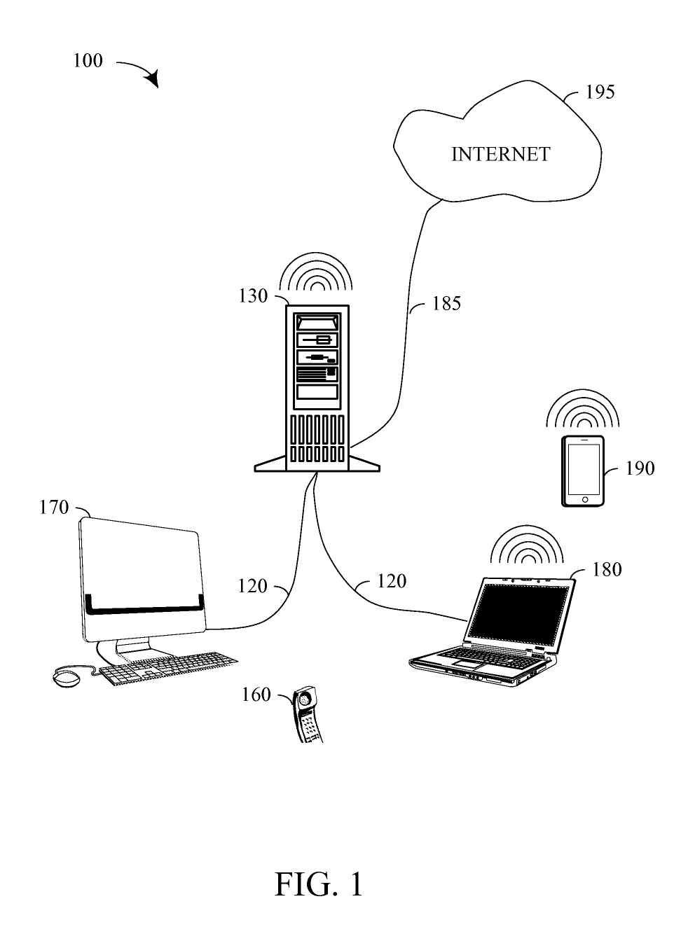

Referring now to FIG. 1, a network computer system 100 for providing tracking and messaging services in accordance with a first preferred exemplary embodiment of the present invention comprises: a data server 130; at least one of a desktop computer 170 and a laptop computer 180; a telephone 160; and a smartphone or Personal Digital Assistant 190 all connected or coupled via a local area network 120 to the Internet 195 via an Internet connection 185.

Taken together, the components of network computer system 100 provide a platform for creating, monitoring, and tracking of messages as a messaging service. Network computer system 100 provides a mechanism for a group of users to efficiently and effectively track, store, monitor, and report the status of multiple targeted messages as well as making decisions and taking actions based upon the patterns and content of the messages, including responses, etc.

In the most preferred embodiments of the present invention, network computer system 100 is configured as a system that will be used to create, monitor, track and report the creation and delivery of targeted messages, in a typical school environment. In this preferred embodiment, the group of users for network computer system 100 will typically include administrators for individual schools as well as school board and school district officials. Further, depending on the specific preferences of the administrators, teachers, parents, and students may also be provided with limited access to various features and functions of network computer system 100. However, it should be noted that the various preferred embodiments of the present invention are suitable for deployment in a wide variety of environments (e.g., businesses, governmental agencies, etc.) wherever and whenever it is desirable to have greater control and efficiency for targeted messaging services as described herein.

Network 120 represents any suitable computer communication link or similar communication mechanism, including some combination of a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over Internet 195 or an internal network (e.g. “intranet”) via a wired or wireless connection, or any other suitable connection between computers and computer components known to those skilled in the art, whether currently known or developed in the future. It should be noted that portions of network 120 might suitably include a dial-up phone connection, a broadcast cable transmission line, a Digital Subscriber Line (DSL), an ISDN line, or similar public utility-like access link.

In the most preferred embodiments of the present invention, at least a portion of network 120 comprises a standard Internet connection 185 between the various components of network computer system 100 for providing access to additional network resources and other remote locations. Network 120 provides for communication between the various components of network computer system 100 and allows for relevant information to be transmitted from device to device. In this fashion, a user of network computer system 100 can quickly and easily gain access to the relevant data and information utilized to search, retrieve, and display information from one or more databases as described in conjunction with the preferred embodiments of the present invention.

In the most preferred embodiments of the present invention, network 120 is configured to provide relatively high-speed transmission of both audio and video data and signals and comprises at least an Internet connection 185 for transmission of data captured by one or more computers 170 or 180 and a phone 160 for transmission of an audio signal to and from a standard phone connection. The phone connection may be interfaced to a standard phone system typically found in most homes and commercial facilities, including for example, the existing “land line” phone system infrastructure and/or digital cellular phone communication systems.

In addition to the other components shown in FIG. 1, a wireless communication access device may be communicatively coupled to network 120 and may be type any wireless communication mechanism that is known to those skilled in the art to provide for wireless communication between network 120 and the various devices associated with network 120, including desktop computer 170, laptop computer 180 and phone 160 as well as smart phone 190. The most preferred embodiments of an acceptable wireless communication access device might comprise any type of wireless bridge, wireless router, or similar type of device (not shown this FIG.).

Regardless of the specific components, physical nature, and topology, network 120 serves to logically and communicatively link the physical components of network computer system 100, thereby enabling stable and consistent communication between the components. This is especially important because in many preferred embodiments of the present invention, data server 130, desktop computer 170, and laptop computer 180 may be geographically remote and/or physically separated from each other.

Data server 130 represents a relatively powerful computer system that is made available to desktop computer 170, laptop computer 180, and/or phone 190 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG. 1) such as database servers, web servers, firewalls, security software, and the like. The use of these various hardware and software components is well known to those skilled in the art. In at least one preferred embodiment, data server 130 is deployed in a hosted environment and used to offer a “cloud computing” or Software as a Service (SAAS) product/service where end users can access the features of system 100 via the Internet.

Given the relative advances in the state-of-the-art computer systems available today, it is anticipated that functions of data server 130 may be provided by many standard, readily available data servers. This may also include the deployment of multiple inter-connected and redundant data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for identifying users and controlling access as well as creating and verifying digital signatures (i.e., electronic signature processing) may also be included.

Desktop computer 170 may be any type of computer system known to those skilled in the art that is capable of being configured for use with network computer system 100 as described herein. It should be noted that no specific operating system or hardware platform is excluded and it is anticipated that many different hardware and software platforms may be configured to create computer 170. As previously explained in conjunction with data server 130, various hardware components and software components (not shown this FIG.) known to those skilled in the art may be used in conjunction with computer 170. It should be noted that in the most preferred embodiments of the present invention, desktop computer 170 is linked (via wired or wireless connection) to its own LAN or WAN and has access to one or more additional data servers (not shown this FIG.).

In addition as shown in FIG. 1, a telephone 160 may be used in conjunction with computer 170 to allow audio messages and alerts to be communicated to telephone 160. In this application, telephone 160 has been communicatively coupled to or otherwise interfaced with the standard telephone communication infrastructure associated with one or more users of network computer system 100. Similarly, audio messages and alerts may be communicated to smartphone 190.

Similarly, laptop computer 180 may be any type of relatively lightweight portable computer system known to those skilled in the art that is capable of being configured for use with network computer system 100 as described herein. This includes tablet computers (e.g., iPad®), pen-based computers and the like. Computer 180 may also be configured to allow the transmission and reception of audio signals, messages, and alerts via server 130 and network 120.

Additionally, netbooks, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be data associated with tracking, monitoring and reporting information regarding targeted messages being created and sent by the users of system 100. The users of desktop computer 170 and/or laptop computer 180 may be program administrators, managers, teachers, parents, and students who are seeking to provide more effective communication for the participants in the overall educational process. Additionally, various related entities such as school boards and school districts, and their employers and agents may also have access to one or more databases located on data server 130 via desktop computer 170 and/or laptop computer 180.

It should be noted that while FIG. 1 shows only a single desktop computer 170 and a single laptop computer 180, it is anticipated that the most preferred embodiments of the present invention will comprise dozens or even hundreds of computers 170 and laptop computers 180. Each of these computers 170 and 180 will be configured to access data server 130 in an appropriately secure way so as to accomplish the specific objectives of the user of the desktop computer 170 or laptop computer 180.

For example, the service provider that controls the databases stored on data server 130 may utilize desktop computer 170 or laptop computer 180 to access data server 130 and create, update or otherwise modify a given database. An operator, located in a remote location, may use desktop computer 170 or laptop computer 180 to access data server 130 to retrieve information about the persons and messages being created and exchanged by the users of network computer system 100.

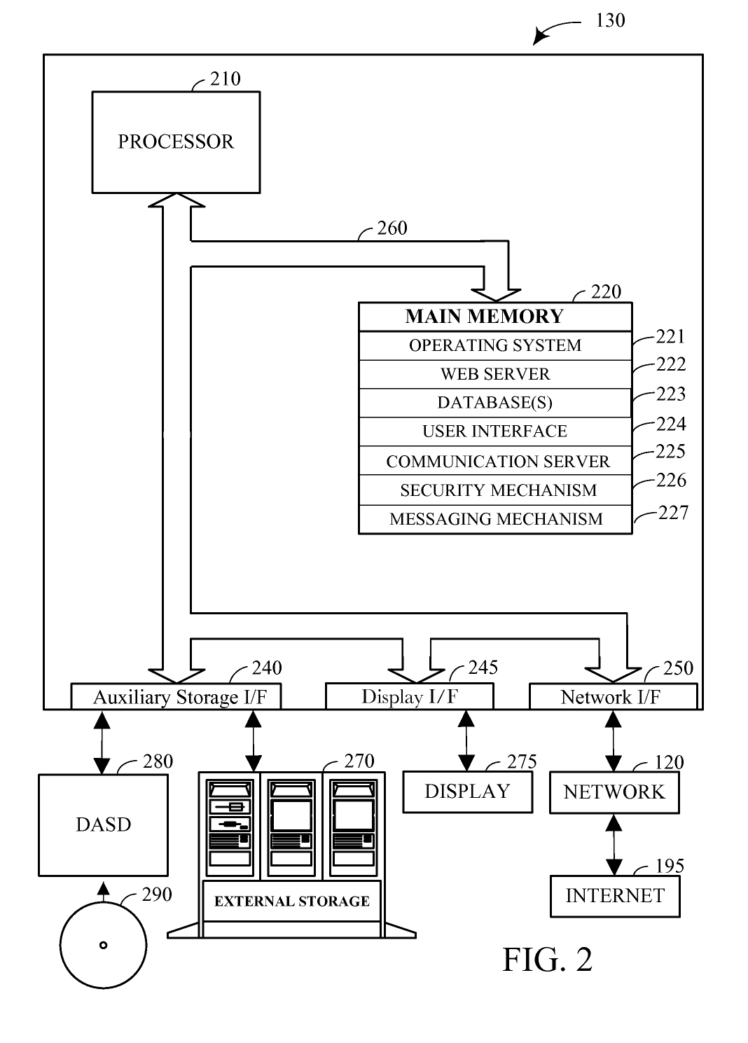

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) environment where data server 130 may be operated as a clearinghouse in a hosted operation. In this fashion, multiple desktop computers 170 and laptop computers 180 will have access to data server 130 and the databases stored thereon via a global computer network such as Internet 195. Data server 130 is further described below in conjunction with FIG. 2 below.

An optional printer and an optional fax machine (not shown this FIG.) may also be deployed for various hard copy data output requirements and may be considered to be any standard peripheral devices used for transmitting or outputting paper-based documents, notes, transaction details, reports, etc. in conjunction with the various requests and transactions processed by network computer system 100 (e.g., reports, statistical analyses, automated letters, etc.) Finally, it should be noted that the optional printer and the optional fax machine are merely representative of the many types of peripherals that may be utilized in conjunction with network computer system 100. It is anticipated that other similar peripheral devices will be deployed in the various preferred embodiment of the present invention and no such device is excluded by its omission in FIG. 1.

Smartphone 190 is representative of any type of cellular device or telephone that may be communicatively coupled to network computer system 100. This includes, for example, personal digital assistants (“PDAs”), Windows® mobile phone devices, Palm® OS devices, Pocket PC® devices, the Apple® iPhone® and other various types of smartphones. Those skilled in the art will recognize these various devices and others that are suitable for deployment as phone 190. While somewhat less powerful than computers 170 and 180, smartphone 190 may also be configured to wirelessly communicate with data server 130 via network 120 to send and retrieve tracking and messaging services related information to and from data server 130.

Given the standard functionality for devices that may be deployed as phone 190, this communication be provided by a wireless Internet connection (e.g. “wi-fi” or “wi-max”) or a Bluetooth® connection. One example of the use for smartphone or PDA 190 in the context of network computer system 100 would to send messages or alerts to a parent of a student, alerting the parent of important information regarding their student's performance or attendance.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of network computer system 100.

Referring now to FIG. 2, data server 130 of FIG. 1 in accordance with a preferred embodiment of the present invention represents one of many commercially available computer systems such as a Linux®-based computer system, an IBM® compatible computer system, or a Macintosh® computer system. However, those skilled in the art will appreciate that the methods and system of the present invention apply equally to any computer system, regardless of the specific operating system and regardless of whether the computer system is a more traditional “mainframe” computer, a complicated multi-user computing device or a single user device such as a personal computer or workstation.

Data server 130 suitably comprises at least one Central Processing Unit (CPU) or processor 210, an auxiliary storage interface 240, a display interface 245, and a network interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 is configured to execute one or more software programs contained within main memory 220. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

Display interface 245 is used to directly connect one or more displays 275 to data server 130. Display 275, which may be non-intelligent (e.g., “dumb”) terminals or fully programmable workstations, are used to provide system administrators and users the ability to communicate with data server 130. Note, however, that while display interface 245 is provided to support communication with one or more displays 275, computer data server 130 does not necessarily require a display 275, because all needed interaction with users and other processes may occur via network 120. Additionally, in certain preferred embodiments, data server 130 may have an integrated display 275.

Network interface 250 is used to connect data server 130 to network 120 and network computer system 100, including computer 170 and computer 180 of FIG. 1. Network interface 250 broadly represents any suitable way to interconnect electronic devices, regardless of whether the network comprises present day analog and/or digital techniques or via some networking mechanism of the future. Network interface 250 preferably includes a combination of hardware and software that allows communications on network 120.

Software provided in conjunction network interface 250 preferably includes a communication manager that manages communication with other computer systems or other network devices via network 120 using a suitable network protocol. Many different network protocols can be used to implement a network. These protocols are specialized computer programs that allow computers to communicate across a network. TCP/IP (Transmission Control Protocol/Internet Protocol) is just one example of a suitable network protocol that may be used by the communication manager contained within network interface 250.

It is important to note that while the present invention has been (and will continue to be) described in the context of a fully functional computer system with certain application software, those skilled in the art will appreciate that the various software mechanisms of the present invention are capable of being distributed as a program product in conjunction with an article of manufacture comprising software stored on a computer readable storage medium in a variety of forms, and that the various preferred embodiments of the present invention applies equally regardless of the particular type or storage medium used to actually carry out the distribution. Examples of computer readable storage media include: recordable type media such as DVD and CD ROMS disks (e.g., disk 290), and transmission type media such as digital and analog communication links, including wireless communication links.

Main memory 220 suitably contains an operating system 221, a web server 222, one or more databases 223, a user interface 224, a communication server 225, a security mechanism 226, and a messaging mechanism 227. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual software mechanisms or components shown in main memory 220 might be combined in various forms and distributed as a stand-alone program product. Finally, it should be noted that additional software components, not shown in this figure, might also be included.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with user interface 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of network computer system 100 of FIG. 1. In the most preferred embodiments of the present invention, database 223 will comprise a plurality of information that may be useful to an organization or individual that wants to perform targeted messaging activities in conjunction with a preferred embodiment of network computer system 100 of FIG. 1. For example, in the most preferred embodiments, database 223 will contain information about the identity and background of message creators (e.g., users of system 100 that will create targeted messages) as well as message recipients (e.g., individuals or groups of individuals that will receive the targeted messages created by the message creators).

User interface 224 is a software component that provides the users of network computer system 100 of FIG. 1 a means for interacting with the various components of network computer system 100. In the most preferred embodiments of the present invention, user interface 224 is a web browser-based graphical interface that is accessible to the users of network computer system 100 via any standard web browser from any computer that is connected to the Internet. Alternatively, user interface 224 may be implemented via a smart phone “app” accessible from smartphone 190, a voice menu system accessible from telephone 160, an interactive voice recognition system, an automated voice recognition system, or combinations thereof. Additional details on user interface 224 are presented below.

In a preferred embodiment of the present invention adapted for tracking performance and attendance in an educational environment, database 223 will typically include a plurality of database records containing information about multiple schools and students (e.g., location, student names, grades, dates and times of attendance, etc.) as well as information about teachers and parents (e.g., names and addresses, contact information, etc.), and specific situation/circumstances associated with one or more messages (e.g., frequency of messages, content of messages, criteria for sending messages, etc.) as well as information providing for tracking, analyzing and reporting information that may be used to provide various targeted messaging services to the users of network computer system 100 of FIG. 1.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 might also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

The most preferred embodiments of network computer system 100 of FIG. 1 will typically include a communication server 225 in main memory 220. Communication server 225 is an automated programmable system that is capable of generating one or more forms of messages or message events. For example, communication server 225 may be configured to send automated email messages or SMS messages to cell phones. Communication server 225 may also be used to generate a hard copy or paper-based document (e.g., mail merge letters) using a printer that are then sent via standard U.S. Postal Service or some type of commercial message delivery company.

Additionally, communication server 225 may be configured to generate a facsimile message by utilizing fax server and a facsimile modem (not shown this FIG.) that is contained in data server 130 of FIG. 2. Communication server 225 is also capable of being configured and used to send and receive various electronic status messages (e.g. audio and video alerts) and updates to data server 130 and between computers 170, 180, and/or 190 of FIG. 1, as may be necessary to enhance the overall process of completing activities related to the provision of targeted messaging services as described herein.

This includes the generation of automated email messages relating to the tracking and reporting of performance and events as well as sending informational messages related to employees, students, etc. Automated or on-demand e-mail messages may also be generated to provide notifications regarding activities and events as well as other information for related to the programs and participants in accordance with the various preferred embodiments of the present invention.

In addition, most preferred embodiments of the present invention might include a security and/or encryption mechanism 226 for verifying access to the data and information contained in and transmitted to and from data server 130. Security mechanism 226 may be incorporated into operating system 221 and/or web server 222. Additionally, security mechanism 226 may also provide encryption capabilities for other components of network computer system 100 of FIG. 1, thereby enhancing the robustness of network computer system 100 of FIG. 1. Security mechanism 226 is most preferably configured to protect the integrity and security of the information transmitted via network 120 of FIG. 1.

Further, depending on the type and quantity of information stored in database 223 and accessed by user interface 224, security mechanism 226 may provide different levels of security and/or encryption for different computer systems 170 and 180 of FIG. 1 and the information stored in database 223. The level and type of security measures applied by security mechanism 226 may be determined by the identity of the end-user and/or the nature of a given request and/or response. In some preferred embodiments of the present invention, security mechanism 226 may be contained in or implemented in conjunction with certain hardware components (not shown this FIG.) such as hardware-based firewalls, switches, dongles, and the like.

In the most preferred embodiments of the present invention, the various components of network computer system 100 of FIG. 1 are able to communicate using multiple communications protocols and systems (e.g., Voice over IP or “VoIP”, Plain Old Telephone Service or “POTS”, etc.). Those skilled in the art will recognize that the communication protocols used herein may be readily adapted and configured to allow for the rapid and efficient transmission and receipt of data by and between the various components of network computer system 100 of FIG. 1. This would also include the ability to control and customize the input and output of network computer system 100 of FIG. 1 for integration with other systems. While a specific exemplary embodiment of a suitable server 130 has been provided above, those skilled in the art will recognize that many other suitable computers (with more or fewer features) may be substituted for the specific example provided herein within departing from the spirit and scope of the present invention.

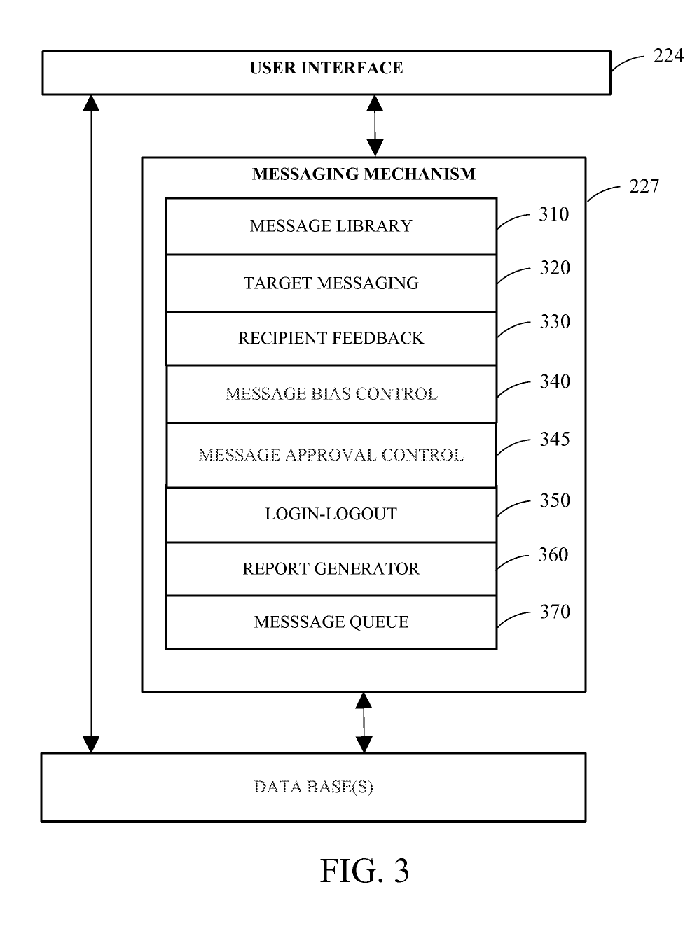

Referring now to FIG. 3, a block diagram of user interaction with a network computer system 100 for providing targeted messaging services in accordance with a preferred exemplary embodiment of the present invention is depicted. As shown in FIG. 3, an end user will communicate with network system 100 via user interface 224, as displayed on one of telephone 160, computer systems 170 and 180 or smartphone 190 FIG. 1. As shown in FIG. 3, user interface 224 provides a way for the users of network computer system 100 of FIG. 1 to interact with the various components of messaging mechanism 227. Interacting with user interface 224 allows an end user to access message library 310, target messaging system 320, recipient feedback system 330, message bias control 340, message approval control 345, login-logout system 350, report generator 360, and message queue 370. In certain circumstances, user interface 224 may be used to access database(s) 223 directly (e.g., adding new records to database(s) 223).

Message library 310 is a software mechanism that is accessed via user interface 224 and provides an end user with the ability to create targeted messages for distribution to one or more message recipients. In the most preferred embodiments of the present invention, message library 310 provides the end user with access to both message templates and messages that are created from the message templates. Each message and each message template may include a message bias. The message bias may be assigned to the message template and/or each individual message at the time of creation or at a later time.

In some preferred embodiments of the present invention, only approved administrators can assign a message bias for a message or message template; while in other preferred embodiments of the present invention, any message creator and/or individual message can assign a message bias; in even other preferred embodiments, certain administrators will be granted the right to designate which message creators are authorized to assign a message bias to a message.

In addition, message library 310 may contain a number of different categories of messages. For example, there may be system level messages that are provided at the time system 100 is installed. Other messages may be created by an organization (e.g., school district or individual school) and individual users, if authorized, can create personalized messages using the templates in message library 310. Messages may be grouped into categories and access to various categories may be restricted or granted as determined by the administrators of system 100. Administrators may create categories or use pre-created categories already in existence. Each template in message library 310 may be assigned to one or more categories.

It is important to note that “messages” may be verbal as well as written messages. For example, a message creator can record and send verbal messages in the same fashion as a written message. In the most preferred embodiments, verbal messages will also be assigned a message bias and delivery schedule. In the most preferred embodiments, verbal messages may be approved in the same manner as written messages. Each message template and each message will have an identifier associated with it. This will allow each message to be tracked and correlated to the message creator for later reporting purposes.

“Message bias” is an indicator assigned to each message template or message describing the general or overall tone of the content contained in a message template or a message created from a message template. In the most preferred embodiments of the present invention, there are four standard categorizations of message bias, “positive,” “negative,” “neutral” and “unknown.” In the most preferred embodiment of the present invention, all messages contained in message library 310 that are assigned an unknown message bias are placed into message queue 370 and will not be sent to any recipients until it is proactively assigned a new message bias, either “positive,” “negative,” “neutral.” It should be noted that, in certain preferred embodiments of the present invention, it may also possible to send a message even if a message bias is unassigned.

Target messaging system 320 is a software mechanism that is accessed via user interface 224 and provides the end user with the ability to batch store and send disparate messages to different recipients or groups of recipients. Unlike other messaging systems, users of system 100 may select or create a first message and a first group of recipients and then select or create a second message and a second group of recipients using a graphical embodiment of user interface 224 (e.g., a “drag and drop” interface) to select the recipients for each message. The message creator may continue in this fashion and create a “batch” of messages. Once the message creator has created all of the desired messages, the message creator may then dispatch all created messages to be sent to the selected recipients in accordance with the selected options and other system parameters (e.g., approval, bias, and timing parameters).

Recipient feedback system 330 is a software mechanism that is accessed via user interface 224 and provides the message creator with the option to select and set response options for each created message. If the response options are selected by the message creator, then the message recipient will be provided with a response option that allows the message recipient to respond to the message. In the case of an email message, there may be a hyperlink provided in the body of the text message. The message recipient may simply click on the hyperlink and launch an email response that will be received and recorded by system 100. Alternatively, the message recipient by be presented with an option to click on a “reply” button to launch an email response. Similarly, a voice message may include a call back number that, when dialed by the message recipient, will allow the message recipient and leave a voice message or, alternatively, respond to a menu system and enter a pre-programmed response to the message. Additionally, a message recipient may specify their preferred method of message receipt and response. If a message recipient has specified email as their preferred method of receiving messages, then verbal messages may be sent as attachments to an email. In any case, the response from the message recipient will be delivered to the message creator or message sender, as appropriate.

Message bias control 340 is a software mechanism that is accessed via user interface 224 and provides the end user with the ability to create, assign, and modify the message bias for each message template and message in message library 310. Even though a message may be automatically assigned a message bias upon creation via inheritance from the message template, it is possible for an approved administrator to change the message bias using message bias control 340.

Message approval control 345 is a software mechanism that is accessed via user interface 224 and enables authorized personnel to approve a message or set approval status for message templates. Since in some preferred embodiments messages cannot be sent until approved, message approval control 345 is a critical component of said some preferred embodiments. There are two ways for a message to be approved via message approval control 345. When a message template is created in message library 310, it may be pre-assigned with “approved” status. In this case, individual messages that are created from that message template will “inherit” approved status as well. That will allow the message to be sent directly from the message queue at the appropriate time without waiting for approval.

In the most preferred embodiments, if a given message is not assigned “approved” status at the time of message creation, then the message will remain in message queue 370 until an authorized user changes the status of the message to “approved.” All users may be allowed to change the approval status of a message but approval authority will generally be reserved to a supervisory user. Additionally, many messages will be identified as “standard” or “stock” messages and assigned approved status by the appropriate user. Once assigned approved status, the message will remain approved and may be sent on a repetitive basis unless the message status is changed to “unapproved.”

If a given message requires manual approval and has been sent to the message queue, then in certain embodiments of system 100, a message will be sent to the message creator to notify the message creator that the message is pending approval. In other embodiments, if the administrator with approval authority chooses not to approve the delivery of a given message, then system 100 may be configured to send a message to the message creator to notify the message creator that the message has been denied approval and will not be delivered by system 100.

Login-logout 350 is a software mechanism that is accessed via user interface 224 and, in conjunction with security mechanism 226 of FIG. 2, provides user access control to network computer system 100 of FIG. 1. Using password and user identification protocols, including password recovery and challenge-response methods, access to network computer system 100 and the associated functions can be controlled and limited as necessary to safeguard and secure the information stored in database 223.

Report generator 360 is a software mechanism that is accessed via user interface 224 and used to create automated and ad-hoc reports based on the operation and functions of network computer system 100. Using report generator 360, a user can access previously created standard reports or create their own reports, to review and evaluate the various performance aspects of network computer system 100 as well as the type, quantity, and content of messages being generated as well as the identity of the individuals who are sending and receiving messages. In the most preferred embodiments of the present invention, it will be possible to generate reports that will aggregate and identify the message bias for all messages generated by network computer system 100.

In at least one preferred embodiment of the present invention, administrative personnel will be able to use report generator 360 to review and analyze patterns of message bias for sent messages. This includes the ability to look at aggregated message bias indicators for a specific message sender, organization, etc. For example, in a school district, the principal of the school will be able to look at the aggregated message bias for an individual teacher or for the entire school. A school district superintendent will be able to view the aggregated message bias for the entire district, each individual school, or any individual teacher in any school. This will allow the administration to determine if the messages being sent are in keeping with the policies and procedures of the organization.

In an alternative deployment environment, report generator 360 may be used by the human resources (“HR”) administrator of a large company to monitor and track the delivery status of HR messages delivered to the company's employees in order to verify compliance with various governmental standards or directives (e.g., EEO, OSHA, etc.) or company guidelines.

Message queue 370 is a storage location for pending messages where the messages are marshaled or stored prior to being sent to the intended recipients. In the most preferred embodiments, messages will remain in message queue 370 until the messages are approved, assigned a message bias, and then sent only upon the appropriate schedule, as determined by the message originator or designated administrator. In the most preferred embodiments, if a message has not been approved, it will not be sent. In the most preferred embodiments, if a message does not have a message bias assigned, it will not be sent. In addition, all messages will have a time designation associated with the message that will control the time for the message to be sent. The time designation may be “immediate” or “scheduled.”

For the most preferred embodiments of the present invention, only when the time designation is satisfied, and the message bias is assigned, and the message has been approved, will a message be released from message queue 370. The time designation for a given message be a specified time (e.g., 7:30 am) or a time period (e.g., between 7:30 am and 5:30 pm) or a given day (e.g., Wednesday, December 27) or group of days (e.g., Wednesday, December 27 through Friday, December 29). This allows the administrator to ensure that messages are timely sent in accordance with the approved organizational policies and procedures. Message may be assigned a delivery schedule by an administrator or the message creator, as designated by the person in charge of making administrative decisions.

With the individual components of messaging mechanism 227 in mind, the overall process for creating, sending, tracking and reporting targeted messaging in conjunction with network computer system 100 can be more fully explained and illustrated.

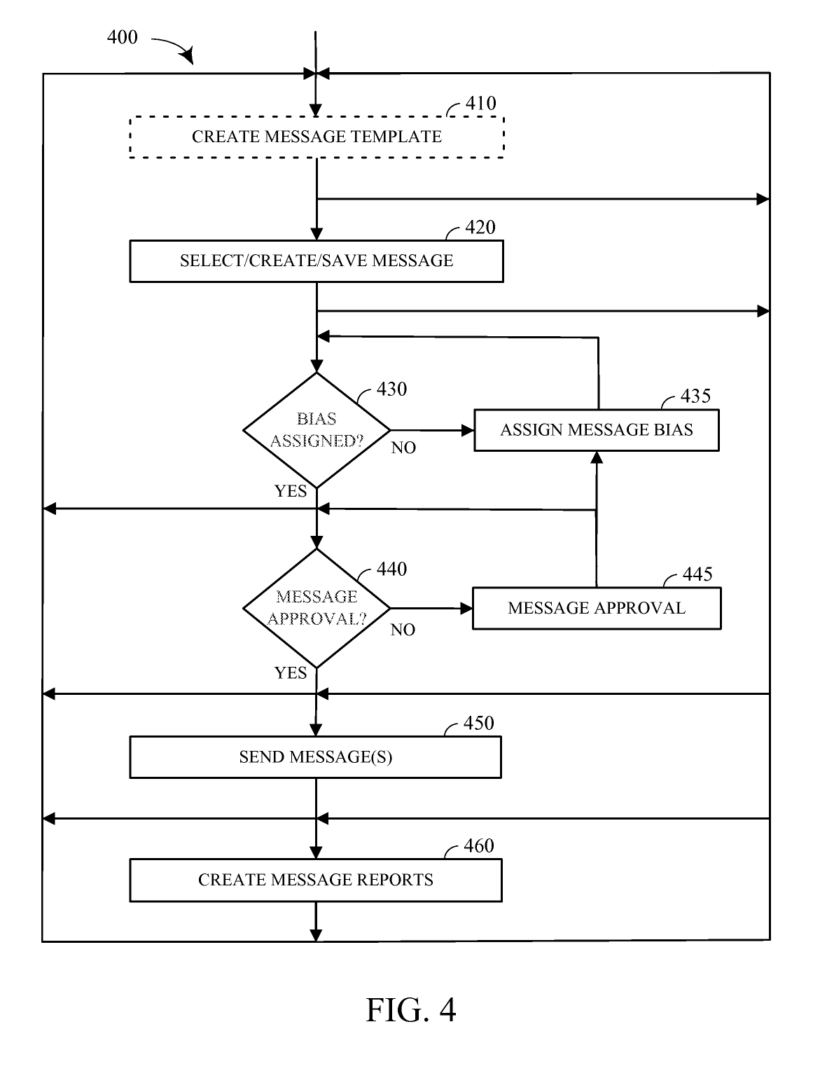

Referring now to FIG. 4, a method 400 for targeted messaging in accordance with a preferred exemplary embodiment of the present invention is depicted. As shown in FIG. 4, a message creator may begin by optionally creating a message template (step 410). However, since only certain users of system 100 of FIG. 1 may be authorized to create templates, the message creator may begin by creating or selecting a message (step 420). When a message creator creates a message, the message creator may create an “ad-hoc” message for a specific purpose, without using a previously created message template. Alternatively, the message creator may select a previously created message template, and use the previously created template as the initial starting point for a new message. Similarly, the message creator may simply select an existing message that already exists in message library 310 of FIG. 3 to use as the initial starting point for a new message. As part of the message creation process, the message creator may also specify the delivery time frame for the newly created message.

In any case, once the desired message has been created or selected, there will be a message bias associated with the newly created message. Depending on system preferences and security settings, etc., the message bias may be assigned by the message creator directly at the time of creation or the message bias may be “inherited” from the original message or message template from which it was created. If a message bias has not been assigned (step 430=“NO”), then the message will not be sent until the message bias has been assigned (step 435), whether automatically or manually.

With a message bias assigned, the message will be checked for appropriate approval prior to being sent (step 440). If a message has not been approved, (step 440=“NO”), then the message will be stored in message queue 370 of FIG. 3 until the message has been approved (step 440=“YES”). At some point in time, the message will be approved (step 445) prior to being sent by system 100 of FIG. 1. It should be noted that message approval (step 445) might be automatic approval or manual approval. Certain templates may be tightly constrained and the content of the message may be “pre-approved.” Provided that the message creator does not alter the contents of the pre-approved template when creating a new message, the newly created message will “inherit” the pre-approved “status” of the message template from which it was created and manual approval will not be necessary. However, if the message creator alters the content of the pre-approved message, and if the message creator does not have message approval authority, then in the most preferred embodiments, the newly created message must still be approved prior to being sent (step 450).

After the message has been created, the message bias assigned, and the message approved, the message is ready to be sent. This may include the sending of multiple messages, depending on the parameters selected by the various message creators using system 100 of FIG. 1. For example, it is possible that multiple message creators may create multiple messages during the course of a given day or period of days. Depending on the approval and delivery parameters associated with each message and system 100, the messages may be delivered over varying periods of time. Some messages may be relatively important and require immediate delivery. Other messages may be more pedestrian in nature and may be delivered at the end of the day or week, for example.

Finally, it should be noted that an additional step (not shown this FIG. 4) might optionally be implemented. In certain environments, a “do not contact” rule may be in place for certain pre-identified potential recipients of messages created via method 400. For example, a certain parent or guardian may have requested that they not receive messages via email or text, or they may have specified that they do not want to receive any communications at all. In these cases, a final check of database 223 for the potential recipient's preferences may be necessary or desirable to ensure that compliance with the potential recipient's preferences is maintained.

After messages have been created, it is possible to create one or more message reports (step 460), based on the messages created. For example, a school principal may wish to view the number of messages sent or to view when messages are being sent. The school may wish to control the number of messages being sent to certain recipients or by certain message creators. In any case, it will be possible to create reports identifying the use of system 100 of FIG. 1 to validate the effectiveness and efficiency of the targeted messages being created and sent by the message creators.

For example, in one preferred embodiment of a report, system 100 returns a list of recipients who responded to a message sent by a teacher so that an administrator can evaluate the level of two-way communication that resulted from the sending of the message. In other reports, system 100 provides an aggregate statistical analysis of the number of two-way communications that resulted from the sending of a message. In another preferred embodiment, approved administrators can set a threshold level for the ratio (“Ratio”) of the number of messages with “positive” bias to the number of messages with “neutral” and/or “negative” bias; the system can then send an alert to an administrator if the Ratio falls below a certain level; alternatively, the system can prevent teachers from sending messages with “negative” or “neutral” bias if the sending of the messages would cause the Ratio to fall below a certain level.

Additionally, as shown by the arrows in FIG. 4, it is possible to create multiple message templates prior to sending any messages. Similarly, it is possible to create many messages prior to sending any message or messages and a strictly linear flow is not required. Basically, any step of the process may be repeated as necessary to accomplish the desired target messaging goals. As previously noted, it may be desirable to create multiple messages, with a different recipient or group of recipients being identified for each message and all messages being sent in a single “batch” sometime after creation of the multiple messages.

It should be noted that each message created by the message creator as shown in FIG. 4 might be any type of message capable of being communicated by system 100 of FIG. 1. As previously explained, that may be a written message (e.g., email, letter, text, etc.) or an audible message (e.g., automated telephone message, audio file attachment to an email, etc.). Additionally, as previously explained, it will be possible for each sent to include a “reply” option providing for the message recipient to respond to the message and the various message responses to be captured and tracked by system 100.

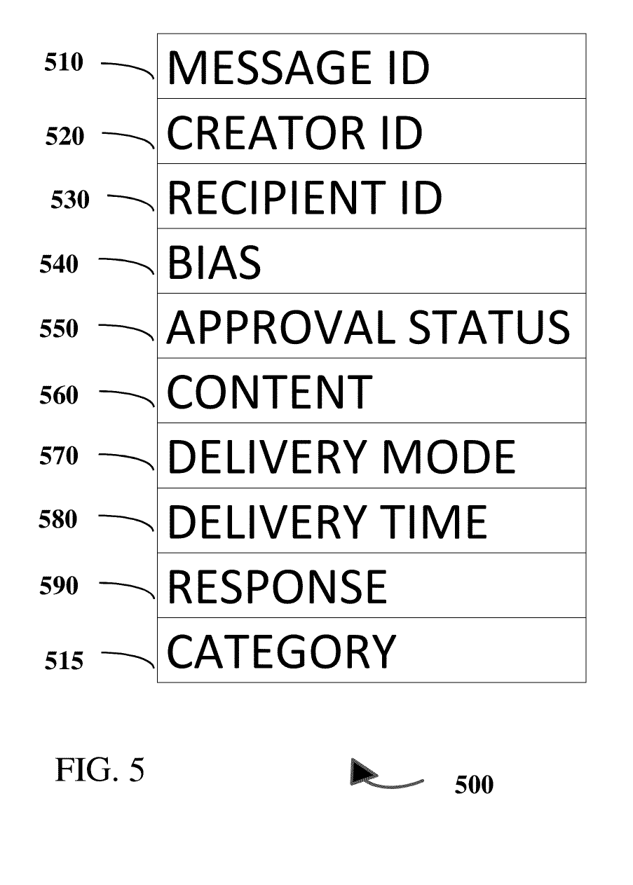

Referring now to FIG. 5, a block diagram of a message 500 in accordance with a preferred exemplary embodiment of the present invention is depicted. As shown in FIG. 5, message 500 may include one or more of the following elements: A message ID 510, a message category 515, a creator ID 520, a recipient ID 530, a message bias 540, an approval status 550, message content 560, a delivery mode 570, a delivery time 580, and a message response 590. It should be noted that not all elements are mandatory and that default values may be applied for one or more message elements. However, in the most preferred embodiments of the present invention, message content 560, message bias 540 and message approval status 550 will always be present.

The relevance and meaning of message ID 510, creator ID 520, and recipient ID 530 are mostly self-explanatory. However, it should be noted that recipient ID 530 might be used to identify a single individual or multiple recipients of message 500. Since each message 500 may be tracked by any of these parameters, reporting on message traffic and flow is flexible and robust. In the most preferred embodiments, as previously explained, message bias 540 will typically be assigned as one of “positive”; “negative”; “neutral”; and “unknown”. The use of message bias 540 will allow administers more effective ways to monitor the type of messages being sent. Approval status 550 is used to track whether or not a given message has been approved for sending. In the most preferred embodiments, until and unless a message has been approved, it will not be sent.

Message category 515 contains the information assigned by a template creator or message creator to categorize each message that is sent by system 100 of FIG. 1. Message category 515 can be important since it may be desirable to create one or more reports where message category 515 is used to determine the number of messages being sent for a given category. For example, at a school, categories may include such items as “class achievement,” “class trips,” etc. For a business, the categories may include such items as “policies and procedures,” “benefits,” etc.

Message content is simply the information that is to be delivered to the message recipient. Delivery mode 570 is utilized to determine how message 500 is to be delivered (e.g., voice, email, text, etc.) and delivery time 580 will provide the time frame for delivery of message 500. It should also be noted that response 590 will be optional for message 500 and the contents of response 590 will be based on the response mechanism provided to the recipient(s) of message 500 (e.g. recorded voice response, email reply, etc.). It should be noted that a given message may be delivered by more than one delivery mode 570 and multiple delivery modes 570 may be specified for any given message to ensure the highest probability of successful message delivery.

As will be appreciated by one skilled in the art, aspects of the disclosed network computer system disclosed herein may be embodied as a system, method or computer program product. Accordingly, aspects of the network computer system may take the form of an hardware embodiment, an software embodiment (including firmware, resident software, micro-code, etc.) or an embodiment combining software and hardware aspects that may all generally be referred to herein as a “circuit,” “module” or “system.” Furthermore, aspects of the network computer system may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), a digital versatile disk (DVD), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the network computer system may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

From the foregoing description, it should be appreciated that system and method for targeted messaging disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A network computer system comprising:
at least one processor;
at least one memory coupled to the at least one processor; and
a message library residing in the at least one memory, the message library comprising a plurality of message templates; and
at least one message sent to at least one message recipient, the at least one message being generated from at least one of the plurality of message templates, the at least one message comprising a message bias.

2. The network computer system of claim 1 wherein the message library further comprises:
a plurality of preapproved messages created from the plurality of message templates, wherein at least one of the preapproved messages comprises a message bias inherited from at least one of the plurality of message templates; and
a plurality of non-preapproved messages, wherein at least one of the non-preapproved messages comprises a message bias.

3. The network computer system of claim 1 further comprising a user interface, the user interface accessing the message library and creating at least one message, the at least one message containing a manually generated message bias.

4. The network computer system of claim 1 further comprising a response to the at least one message, the response being generated by the at least one message recipient.

5. The network computer system of claim 1 further comprising a report, the report comprising a plurality of information, the plurality of information comprising at least a message ID, a message creator ID, a message recipient ID and the message bias for the at least one message.

6. The network computer system of claim 1 wherein the at least one message comprises:
a message category;
a creator ID;
a recipient ID;
a message bias;
an approval status;
message content
at least one delivery mode;
a delivery time; and
a message response.

7. The network computer system of claim 1 wherein the at least one message comprises at least one of:
a text message;
a voice message;
a still image;
a video image;
a paper-based document; and

8. The network computer system of claim 1 further comprising:
an operating system residing in the at least one memory;
a web server residing in the at least one memory;
a communication server residing in the at least one memory;
a security mechanism residing in the at least one memory; and
a messaging mechanism residing in the at least one memory, the messaging mechanism comprising at least:
the message library;
a message bias control;
a message approval control;
a message queue; and
a report generator.

9. The network computer system of claim 1 wherein the network computer system further comprises:
an operating system residing in the at least one memory;
a web server residing in the at least one memory;
a communication server residing in the at least one memory;
a messaging mechanism residing in the at least one memory, the messaging mechanism comprising at least:
the message library;
a message bias control;
and wherein the at least one message comprises:
a message category;
a creator ID;
a recipient ID;
a message bias;
an approval status;
a message content
at least one delivery mode;
a delivery time; and
a message response.

10. The network computer system of claim 9 wherein the at least one message comprises a plurality of messages, wherein each of the plurality of messages comprises:
a message category;
a creator ID;
a recipient ID;
a message bias;
an approval status;
a message content;
at least one delivery mode;
a delivery time; and
a message response;
and further comprising at least one report residing in the memory, the at least one report comprising aggregated data derived from the plurality of messages, including at least an aggregated message bias.

11. The network computer system of claim 1 wherein the at least one processor and the at least one memory are deployed in a hosted environment and accessed via the Internet.

12. The network computer system of claim 9 wherein the delivery mode comprises a social media message delivery service.

13. A computer-implemented method for messaging, the method comprising the steps of:
creating at least one message;
assigning a message bias to the at least one message;
gaining approval for the at least one message; and
sending the at least one message to at least one message recipient.

14. The computer-implemented method of claim 13 wherein the step of assigning a message bias to the at least one message comprises the step of selecting a message bias from the group consisting of: “positive”; “negative”; “neutral”; and “unknown” and assigning the selected message bias to the at least one message.

15. The computer-implemented method of claim 13 further comprising the step of assigning a specific color to represent the message bias assigned to the at least one message.

16. The computer-implemented method of claim 13 wherein the step of assigning a message bias to the at least one message comprises the step of:
selecting a message bias from the group consisting of: “positive”; “negative”; “neutral”; and “unknown” and assigning the selected message bias to the at least one message; and
further comprising the step of assigning a specific color to represent the message bias assigned to the at least one message.

17. The computer-implemented method of claim 13 wherein the step of gaining approval for the at least one message comprises the steps of:
sending the at least one message to at least one human administrator prior to sending the message; and
marking the at least one message as an approved message.

18. The computer-implemented method of claim 13 wherein the step of gaining approval for the at least one message comprises the steps of:
checking a record in a database to determine if the at least one message is a “pre-approved” message; and
sending the at least one message without any human intervention if the at least one message is a “pre-approved” message.

19. The computer-implemented method of claim 13 wherein the step of gaining approval for the at least one message comprises the steps of:
checking a record in a database to determine if the message originator is a “pre-approved” message originator; and
sending the at least one message without any human intervention if the message originator is a “pre-approved” message originator.

20. The computer-implemented method of claim 13 further comprising the steps of:
monitoring a plurality of sent messages;
noting the message bias for each of the plurality of sent messages;
tabulating an aggregate message bias for the plurality of sent messages.

21. The computer-implemented method of claim 20 wherein the step of tabulating an aggregate message bias for the plurality of sent messages comprises the step of tabulating an aggregate message bias for the plurality of sent messages sent by a single message creator.

22. The computer-implemented method of claim 20 wherein the step of tabulating an aggregate message bias for the plurality of sent messages comprises the step of tabulating an aggregate message bias for the plurality of sent messages sent by a selected group of individuals.

23. The computer-implemented method of claim 20 wherein the step of tabulating an aggregate message bias for the plurality of sent messages comprises the step of tabulating an aggregate message bias for the plurality of sent messages sent by a single organization.

24. The computer-implemented method of claim 20 wherein the step of tabulating an aggregate message bias for the plurality of sent messages comprises at least one of the steps of:
tabulating an aggregate message bias for the plurality of sent messages sent by a single message creator;
tabulating an aggregate message bias for the plurality of sent messages sent by a selected group of individuals; and
tabulating an aggregate message bias for the plurality of sent messages sent by a single organization.

25. The computer-implemented method of claim 20 further comprising the step of reporting the aggregate message bias for the plurality of sent messages to one or more reviewers.

26. The computer-implemented method of claim 13 wherein the method is offered via a hosted service and is accessed via the Internet.
